(19) United States
(12) Patent Application Publication
(10) Pub. No.: US 2010/0326543 A1
(43) Pub. Date: Dec. 30, 2010

(54) PRESSURE CONTROL VALVE

(75) Inventors: Ralph BOEHM, Bodmann-Ludwigshafen (DE); Karlheinz MAYR, Bregenz (AT); Stefan MESCHENMOSER, Friedrichshafen (DE); Thilo SCHMIDT, Meckenbeuren (DE); Georg GIERER, Kressbronn (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/818,313

(22) Filed: Jun. 18, 2010

(30) Foreign Application Priority Data
Jun. 24, 2009 (DE) 10 2009 027 130.9

(51) Int. Cl. F16K 31/04

(52) U.S. Cl. 137/487.5

(57) ABSTRACT

A pressure control valve for at least one of controlling and/or regulating a pressure level in a hydraulic circuit. The control valve comprises a valve housing (1) in which a control element (2), that can be acted upon by a system pressure (P_Sys), is arranged to move. The control element (2) is coupled to a drive mechanism in order to set an operating pressure (P_Kpl). At least one linear motor (3) is provided as the drive mechanism which can be controlled at least by a signal feedback (4) acting as a control circuit as a function of the operating pressure (P_Kpl) actually set at the time.

This application claims priority from German patent application serial No. 10 2009 027 130.9 filed Jun. 24, 2009.

### FIELD OF THE INVENTION

The present invention concerns a pressure control valve for controlling and/or regulating a pressure level in a hydraulic circuit.

### BACKGROUND OF THE INVENTION

A pressure control valve of this type is known, for example from the document DE 103 43 843 A1. This pressure control valve comprises, in the usual manner, a housing in which a control element designed as a closing body is arranged and can move, and this is acted upon by pressure. Further, in the housing a yoke is provided, in which an armature assembly surrounded by a magnetic solenoid is positioned, the armature assembly comprising an armature rod in which a pin is inserted. The size of the pin and the material used for it are chosen such that a length change of a plastic flange caused by temperature is compensated, in order to avoid any variation of the working pressure while the magnetic valve is energized with a constant current.

### SUMMARY OF THE INVENTION

The purpose of the present invention is to modify a pressure control valve of the type described above in such manner that the control behavior is further improved.

Thus, a pressure control valve for controlling and/or regulating a pressure level in a hydraulic circuit is now available, for example one in a motor vehicle for the hydraulic actuation of shift elements, in particular disk clutches for torque transmission, the valve comprising a valve housing in which is arranged a control element, for example a valve slide, that can be acted upon by a system pressure and which is coupled to a drive mechanism for setting a predetermined operating pressure. According to the invention at least one linear motor can be provided as the drive mechanism, which can be actuated at least by a signal feedback acting as a control circuit as a function of the operating pressure set in each case.

With the proposed pressure control valve the linear motor produces a constant adjusting force proportional to the current over a defined adjustment range, so that operation-related adjustment differences, which can for example be caused by temperature-related viscosity variations of the fluid flowing through, are compensated by virtue of comparable nominal value specification. Thanks to a drive mechanism of this type with the signal back-coupling or signal feedback used, the behavior of the system is determined definitively so that due to the operation of the pressure control valve as a hydraulically regulated pressure balance, clear advantages are achieved with regard to the system behavior even when superimposed control circuits are used.

In one possible embodiment it can be arranged that for signal feedback purposes at least one pressure sensor is provided for determining the set operating pressure, in particular the clutch pressure for actuating a clutch piston in order to compress a disk clutch, the pressure signal being converted by the pressure sensor to a voltage signal. The voltage signal is then used to control the linear motor, so ensuring a feedback for regulating the drive mechanism.

Another possibility for signal feedback can be to use a force sensor to detect the force acting at any time between the control element and the linear motor, the said force sensor converting the force signal to a voltage signal. Other signal feedback methods too are possible.

With the proposed pressure control valve, if in addition a hydraulic feedback between the operating pressure and the system pressure is provided as a control circuit, then so-called superimposed control circuits for controlling and/or regulating the pressure level in the hydraulic circuit are formed, and this improves the overall control still more.

In a related further development of the invention it can be provided that the linear motor is, for example, connected directly to the control element. This gives a relatively rigid connection between the drive and the control element in the pressure control valve. A coupling member can also be provided for the connection between the linear motor and the control element. As the coupling member either a rigid element or else a damping element such as a spring can be used.

Preferably, a spindle drive can be used as the linear motor. However, other linear motors too can be used to actuate the control element in the pressure control valve proposed according to the invention.

The pressure control valve can be used, for example, to actuate a shifting element in a motor vehicle. For example, the compression force applied to a disk packet of a disk clutch by a hydraulically actuated clutch piston can be controlled in this way. However, other fields of use as well are conceivable.

### BRIEF DESCRIPTION OF THE DRAWINGS

Below, the present invention is explained in more detail with reference to the drawings, in which various example embodiments are shown. Specifically, the figures show:

FIG. 1: Schematic view of a first possible embodiment variant of a pressure control valve according to the invention;

FIG. 2: Schematic view of a second possible embodiment variant of the pressure control valve; and

FIG. 3: Schematic view of a third possible embodiment variant of the pressure control valve.

### DETAILED DESCRIPTION OF THE PREFERRED EMBODIMENTS

In the figures, embodiment variants of a pressure control valve according to the invention for controlling and/or regulating a pressure level in a hydraulic circuit, for example for the hydraulic actuation of a disk clutch (not shown), are illustrated in a purely schematic manner.

Regardless of the specific embodiment variant the pressure control valve comprises a valve housing 1, in which is arranged a control element acted upon by a system pressure P_Sys; in the example embodiment illustrated a valve slide 2 is provided as an example of the control element. The valve slide 2 is coupled to a drive mechanism in order to set a predetermined operating pressure, this operating pressure corresponding to a clutch pressure P_Kpl in the example embodiment shown.

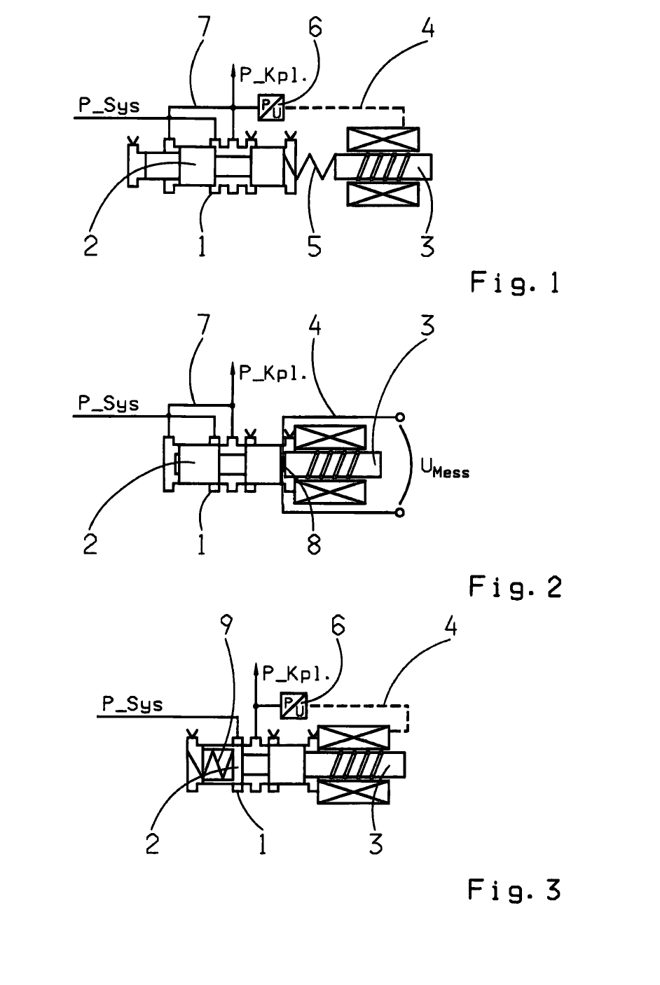

In the first possible embodiment variant of the pressure control valve according to the invention, shown in FIG. 1, the linear motor 3 is connected to the control element or valve slide 2 in the valve housing 1 by a coupling member in the form of a spring element 5, so that the control movements effected by the linear motor 3 are transmitted to the valve slide 2 in order to set a desired clutch pressure P_Kpl. As the signal feedback a pressure sensor 6 is provided, which detects the actual clutch pressure set and converts the pressure signal to a corresponding voltage signal so that, by virtue of the signal feedback, the actual clutch pressure set is taken into account for the control of the linear motor 3. As a further control circuit a hydraulic feedback 7 between the clutch pressure P_Kpl and the system pressure P_Sys is provided. In this way the proposed pressure control valve is treated as a hydraulic pressure balance by virtue of the superimposed control circuit, in order to thereby to achieve better regulation dynamics.

FIG. 2 shows a second embodiment variant of the pressure control valve according to the invention. In this second embodiment variant, in contrast to the first embodiment variant a force sensor 8 is provided as the coupling member between the linear motor 3 and the valve slide 2. This force sensor 8 serves at the same time as a signal feedback 4 since the force sensor 8 detects the force acting between the valve slide 2 and the linear motor 3 at any time and converts the force signal to a corresponding voltage signal U_{Mess}. The voltage signal U_{Mess} is taken into account by the control of the linear motor 3 for adjusting the clutch pressure P_Kpl. In the second embodiment variant as well, an additional hydraulic feedback 7 is provided, so that here too there are superimposed control circuits. In this way the pressure control valve or clutch valve is controlled directly by the linear motor 3, for example with self-locking, so that particularly high oscillation stability of the control is obtained. In addition, since the force sensor 8 is made as a coupling member, little space is required for force sensing.

The third possible example embodiment is shown in FIG. 3. In this third embodiment variant the linear motor 3 is connected directly to the valve slide 2 or control element, i.e. without any intermediate coupling member. The valve slide 2 is pre-stressed by a spring 9 since in this third embodiment variant no hydraulic feedback 7 is provided. As in the first embodiment variant, for the signal feedback 4, a pressure sensor 6 is provided to detect the actual clutch pressure P_Kpl or operating pressure applied. In this embodiment variant too particularly oscillation-stable control is achieved.

### INDEXES

1 Valve housing
2 Valve slide or control element
3 Linear motor
4 Signal feedback
5 Spring element
6 Pressure sensor
7 Hydraulic feedback
8 Force sensor
9 Spring
P_Kpl Clutch or operating pressure
P_Sys System pressure
U_{Mess} Voltage signal

1-8. (canceled)

9. A pressure control valve for at least one of controlling and regulating a pressure level in a hydraulic circuit, the control valve comprising:
a valve housing (1);
a control element (2) being located within the valve housing (1) and being acted upon and movable by a system pressure (P_Sys), and
the control element (2) being coupled to a drive mechanism to set an operating pressure (P_Kpl),
wherein at least one linear motor (3) is provided as the drive mechanism, and the at least one linear motor (3) is controllable at least by a signal feedback (4) acting as a control circuit as a function of the operating pressure (P_Kpl) actually set at a time.

10. The pressure control valve according to claim 9, wherein the signal feedback (4) comprises at least one pressure sensor (6) for detecting the operating pressure (P_Kpl) actually set, and the sensor converts a pressure signal into a voltage signal.

11. The pressure control valve according to claim 9, wherein as the signal feedback (4) comprises at least one force sensor (8) for detecting a force acting between the control element (2) and the at least one linear motor (3), and the sensor converts the pressure signal into a voltage signal.

12. The pressure control valve according to claim 9, wherein a hydraulic feedback (7) is provided as a control circuit between the operating pressure (P_Kpl) and the system pressure (P_Sys).

13. The pressure control valve according to claim 9, wherein the at least one linear motor (3) is connected directly to the control element (2).

14. The pressure control valve according to claim 9, wherein the linear motor (3) is connected to the control element (2) via a coupling member.

15. The pressure control valve according to claim 9, wherein a spindle drive is provided as the linear motor (3).

16. The pressure control valve according to claim 9, wherein the pressure control valve is used for actuating a shifting element in a motor vehicle.

17. A pressure control valve for at least one of controlling and regulating a pressure level in a hydraulic circuit, the pressure control valve comprising:
a valve housing (1) accommodating a control element (2) being acted upon by a system pressure (P_Sys),
the control element (2) being biased by a linear motor (3) to set an operating pressure (P_Kpl), and
the linear motor (3) being controllable by a signal feedback (4) as a function of the operating pressure (P_Kpl).
